(19) United States
(12) Patent Application Publication
(10) Pub. No.: US 2013/0110477 A1
(43) Pub. Date: May 2, 2013

(54) PROCESS VARIATION-BASED MODEL OPTIMIZATION FOR METROLOGY

(71) Applicant: Stilian Pandev, Santa Clara, CA (US)

(72) Inventor: Stilian Pandev, Santa Clara, CA (US)

(21) Appl. No.: 13/286,079

(22) Filed: Oct. 31, 2011

(51) Int. Cl. G06F 17/50

(52) U.S. Cl. 703/2

(57) ABSTRACT

Process variation-based model optimization for metrology is described. For example, a method includes determining a first model of a structure. The first model is based on a first set of parameters. A set of process variations data is determined for the structure. The first model of the structure is modified to provide a second model of the structure based on the set of process variations data. The second model of the structure is based on a second set of parameters different from the first set of parameters. A simulated spectrum derived from the second model of the structure is then provided.

### TECHNICAL FIELD

Embodiments of the present invention are in the field of metrology, and, more particularly, relate to methods of process variation-based model optimization for metrology.

### BACKGROUND

For the past several years, a rigorous couple wave approach (RCWA) and similar algorithms have been widely used for the study and design of diffraction structures. In the RCWA approach, the profiles of periodic structures are approximated by a given number of sufficiently thin planar grating slabs. Specifically, RCWA involves three main operations, namely, the Fourier expansion of the field inside the grating, calculation of the eigenvalues and eigenvectors of a constant coefficient matrix that characterizes the diffracted signal, and solution of a linear system deduced from the boundary matching conditions. RCWA divides the problem into three distinct spatial regions: (1) the ambient region supporting the incident plane wave field and a summation over all reflected diffracted orders, (2) the grating structure and underlying non-patterned layers in which the wave field is treated as a superposition of modes associated with each diffracted order, and (3) the substrate containing the transmitted wave field.

The accuracy of the RCWA solution depends, in part, on the number of terms retained in the space-harmonic expansion of the wave fields, with conservation of energy being satisfied in general. The number of terms retained is a function of the number of diffraction orders considered during the calculations. Efficient generation of a simulated diffraction signal for a given hypothetical profile involves selection of the optimal set of diffraction orders at each wavelength for both transverse-magnetic (TM) and/or transverse-electric (TE) components of the diffraction signal. Mathematically, the more diffraction orders selected, the more accurate the simulations. However, the higher the number of diffraction orders, the more computation is required for calculating the simulated diffraction signal. Moreover, the computation time is a nonlinear function of the number of orders used.

The input to the RCWA calculation is a profile or model of the periodic structure. In some cases cross-sectional electron micrographs are available (from, for example, a scanning electron microscope or a transmission electron microscope). When available, such images can be used to guide the construction of the model. However a wafer cannot be cross sectioned until all desired processing operations have been completed, which may take many days or weeks, depending on the number of subsequent processing operations. Even after all the desired processing operations are complete, the process to generate cross sectional images can take many hours to a few days because of the many operations involved in sample preparation and in finding the right location to image. Furthermore the cross section process is expensive because of the time, skilled labor and sophisticated equipment needed, and it destroys the wafer.

Thus, there is a need for a method for efficiently generating an accurate model of a periodic structure given limited information about that structure, a method for optimizing the parameterization of that structure and a method of optimizing the measurement of that structure.

### SUMMARY

Embodiments of the present invention include methods of process variation-based model optimization for metrology.

In an embodiment, a method of optimizing parametric models for structural analysis using metrology of repeating structures on a semiconductor substrate or wafer includes determining a first model of a structure. The first model is based on a first set of parameters. A set of process variations data is determined for the structure. The first model of the structure is modified to provide a second model of the structure based on the set of process variations data. The second model of the structure is based on a second set of parameters different from the first set of parameters. A simulated spectrum derived from the second model of the structure is provided.

In another embodiment, a machine-accessible storage medium has instructions stored thereon which cause a data processing system to perform a method of optimizing parametric models for structural analysis using metrology of repeating structures on a semiconductor substrate or wafer. The method includes determining a first model of a structure. The first model is based on a first set of parameters. A set of process variations data is determined for the structure. The first model of the structure is modified to provide a second model of the structure based on the set of process variations data. The second model of the structure is based on a second set of parameters different from the first set of parameters. A simulated spectrum derived from the second model of the structure is provided.

In another embodiment, a system to generate a simulated diffraction signal to determine process parameters of a wafer application to fabricate a structure on a wafer using optical metrology includes a fabrication cluster configured to perform a wafer application to fabricate a structure on a wafer. One or more process parameters characterize behavior of structure shape or layer thickness when the structure undergoes processing operations in the wafer application performed using the fabrication cluster. Also included is an optical metrology system configured to determine the one or more process parameters of the wafer application. The optical metrology system includes a beam source and detector configured to measure a diffraction signal of the structure. The optical metrology system also includes a processor configured to determine a first model of a structure, the first model based on a first set of parameters, configured to determine a set of process variations data for the structure, configured to modify the first model of the structure to provide a second model of the structure based on the set of process variations data, the second model of the structure based on a second set of parameters different from the first set of parameters, and configured to provide a simulated spectrum derived from the second model of the structure.

### BRIEF DESCRIPTION OF THE DRAWINGS

FIG. 1 illustrates an angled view of a double cross-section of a semiconductor structure fabricated by a process methodology, in accordance with an embodiment of the present invention.

FIG. 2 illustrates an angled view of a double cross-section of a semiconductor structure model which may be used to model the structure of FIG. 1, in accordance with an embodiment of the present invention.

FIG. 3 is a plot of model DOF along a first axis, process DOF along a second orthogonal axis, and an optimal fit axis located between the first and second axis, in accordance with an embodiment of the present invention.

FIGS. 4A and 4B illustrate a plot for 10 floated parameters, and a corresponding correlation outcome for the 10 parameters, respectively, in accordance with an embodiment of the present invention.

FIG. 5 depicts a flowchart representing an exemplary series of operations for determining and utilizing structural parameters for automated process and equipment control, in accordance with an embodiment of the present invention.

FIG. 6 is an exemplary block diagram of a system for determining and utilizing structural parameters for automated process and equipment control, in accordance with an embodiment of the present invention.

FIG. 7 depicts a flowchart representing operations in a method of process variation-based model optimization for metrology, in accordance with an embodiment of the present invention.

FIG. 8 depicts a flowchart representing operations in a method of reducing the degrees of freedom (DoF) of a set of parameters, in accordance with an embodiment of the present invention.

FIG. 9 includes plots of possible process ranges which correspond to plots of library size, in accordance with an embodiment of the present invention.

FIG. 10A depicts a periodic grating having a profile that varies in the x-y plane, in accordance with an embodiment of the present invention.

FIG. 10B depicts a periodic grating having a profile that varies in the x-direction but not in the y-direction, in accordance with an embodiment of the present invention.

FIG. 11 represents a cross-sectional view of a structure having both a two-dimensional component and a three-dimensional component, in accordance with an embodiment of the present invention.

FIG. 12 is a first architectural diagram illustrating the utilization of optical metrology to determine parameters of structures on a semiconductor wafer, in accordance with embodiments of the present invention.

FIG. 13 is a second architectural diagram illustrating the utilization of optical metrology to determine parameters of structures on a semiconductor wafer, in accordance with embodiments of the present invention.

FIG. 14 illustrates a block diagram of an exemplary computer system, in accordance with an embodiment of the present invention.

FIG. 15 is a flowchart representing operations in a method for a building parameterized model and a spectral library beginning with sample spectra, in accordance with an embodiment of the present invention.

FIG. 16 is an illustrative flowchart representing operations in a method for building a library for making production measurements of a structure, in accordance with an embodiment of this invention.

FIG. 17 is an illustrative flowchart representing operations in a method for building a real-time regression measurement recipe for making production measurements of a structure, in accordance with an embodiment of this invention.

### DETAILED DESCRIPTION

Methods of process variation-based model optimization for metrology are described herein. In the following description, numerous specific details are set forth, such as specific approaches to reducing the number of degrees of freedom (DoF) of a set of parameters for analysis, in order to provide a thorough understanding of embodiments of the present invention. It will be apparent to one skilled in the art that embodiments of the present invention may be practiced without these specific details. In other instances, well-known processing operations, such as fabricating stacks of patterned material layers, are not described in detail in order to not unnecessarily obscure embodiments of the present invention. Furthermore, it is to be understood that the various embodiments shown in the figures are illustrative representations and are not necessarily drawn to scale.

Embodiments of the present invention may be directed toward improving a model, such as an optical model. The improvement or optimization may be achieved by reducing a modeled space and library size, choosing a best parameterization, or reducing the model degrees of freedom (DOF). The benefits may be realized with minimal cost, such as computation cost, and a reduced time for regression. One or more embodiments may include analysis and library generation, improving library training, improving an analysis sensitivity and correlation results, reducing library toggling effect and improving a library-to-regression matching. In one particular embodiment, the model parameters are constrained only within the process variation space, reducing the overall time to results.

Process variations data may be used to improve a model for, e.g., optical metrology comparison. In an embodiment, a method includes prediction of the DOF needed for modeling a particular structure and processes. In one such embodiment, two approaches are defined for non-geometric parameterization: PCA and Function+Delta. The Function+Delta type of parameterization may be applied to linear and non-liner parameter correlation. Modeled parameter space reduction (e.g., library size reduction) may be achieved for liner and non-linear parameter spaces in this way. As a result, one or more of the approaches described herein may be used to improve corresponding sensitivity and correlation analysis results.

Furthermore, in an embodiment, auto wavelength selection is performed by sampling the space defined by the process variation. The space is defined by the parameterization. In one embodiment, one or more approaches herein may be used to improve the regression results by allowing the regression to search only in the space defined by the expected process variations. In the case that PCA parameterization is used, the parameterization may be based on the process variation data. A mechanism for describing the expected process variation without actual process data may also be enabled. In one embodiment, a method is used to define a mechanism for estimating the expected geometric parameter error of fixing a parameter of the re-parameterized model.

One or more embodiments described herein may be characterized as process variation-based degrees of freedom (DOF) reduction. Such approaches may be used to address challenges defining a model parameterization. A comparison or determination of a model number of DOF may be correlated with or defined from a number of process DOF. Some approaches may further include systematic re-parameterization. In doing so, library size and accuracy may be improved, errors associated with fixing a parameter may be reduced, and/or time-to-result may be improved.

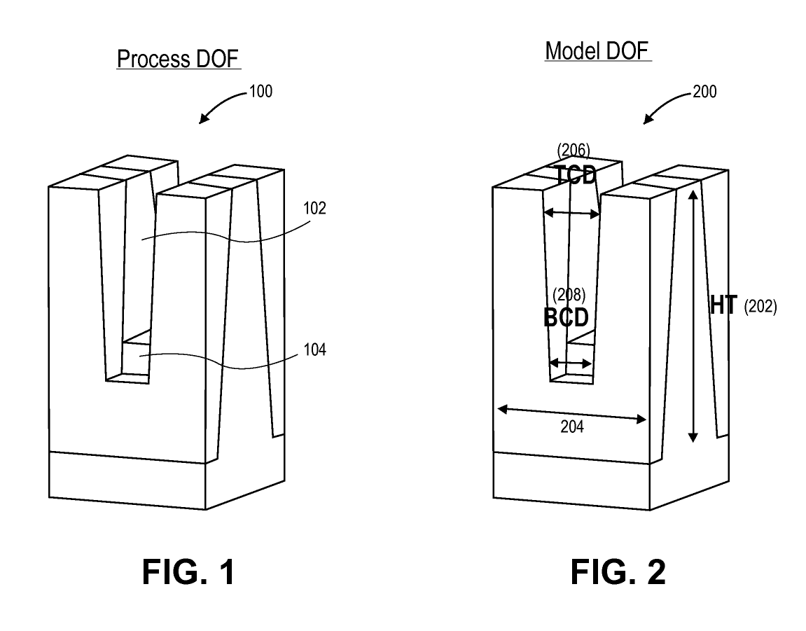

As an example of one of many possible re-parameterizations contemplated within the spirit and scope of embodiments of the present invention, parameters of a three-dimensional structure may be selected for modeling purposes. FIG. 1 illustrates an angled view of a double cross-section of a semiconductor structure 100 fabricated by a process methodology, in accordance with an embodiment of the present invention. As an example, semiconductor structure has an etch feature 102 and internal topography 104 within the etch feature 102. As a consequence of the process used to fabricate semiconductor structure 100, such as an etch process, realistically there is only a subset of options for the overall shape and detailed features of the structure.

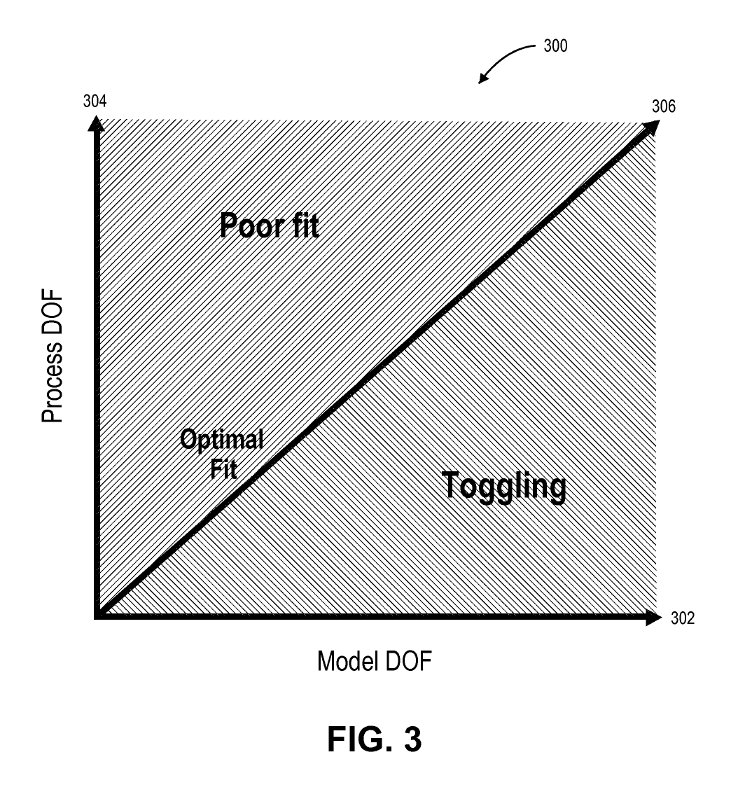

Thus, not every possible combination need be used for modeling such a structure. For example, FIG. 2 illustrates an angled view of a double cross-section of a semiconductor structure model 200 which may be used to model the structure of FIG. 1, in accordance with an embodiment of the present invention. Referring to FIG. 2, since there are finite possible outcomes with respect to fabricating structure 100, the model 200 focuses on a subset of parameters. As a specific, but non-limiting example, structure height (HT) 202, structure width (204), top critical dimension (TCD) 206 and bottom critical dimension (BCD) 208 are shown as possible parameters that may be analyzed in a modeling process.

Thus, although process variations will inevitably change the geometry of a resulting structure, multiple features may be affected in a similar way. That is, the parameters may be viewed as correlated. Process DOF is the number of independent variations. The user decides how many parameters to float. Model DOF is the number of geometric parameters that user selected to float.

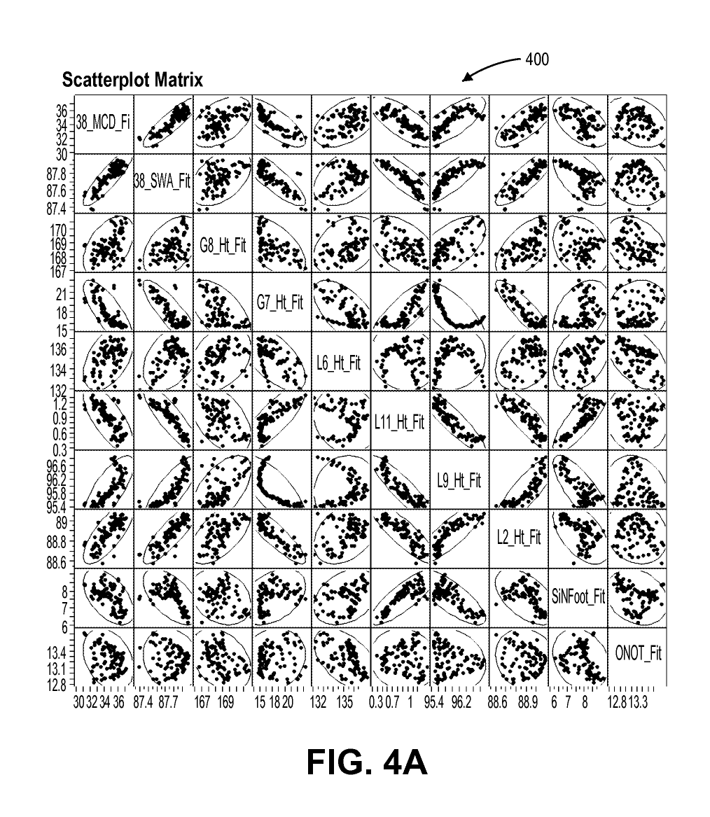

To further illustrate the relationship between process DOF and model DOF, FIG. 3 is a plot 300 of model DOF along a first axis 302, process DOF along a second orthogonal axis 304, and an optimal fit axis 306 located between the first and second axis, in accordance with an embodiment of the present invention. Referring to plot 300, in the space overly proximate to the process DOF axis 304, a poor modeling fit is achieved. For example, certain features may not be modeled or are underdefined. By contrast, in the space overly proximate to the model DOF axis 302, toggling may result. For example, there may be multiple minima or feature parameters may be overdefined in this space. Accordingly, the optimal fit 306 is not overly proximate to either of axes 302 or 304.

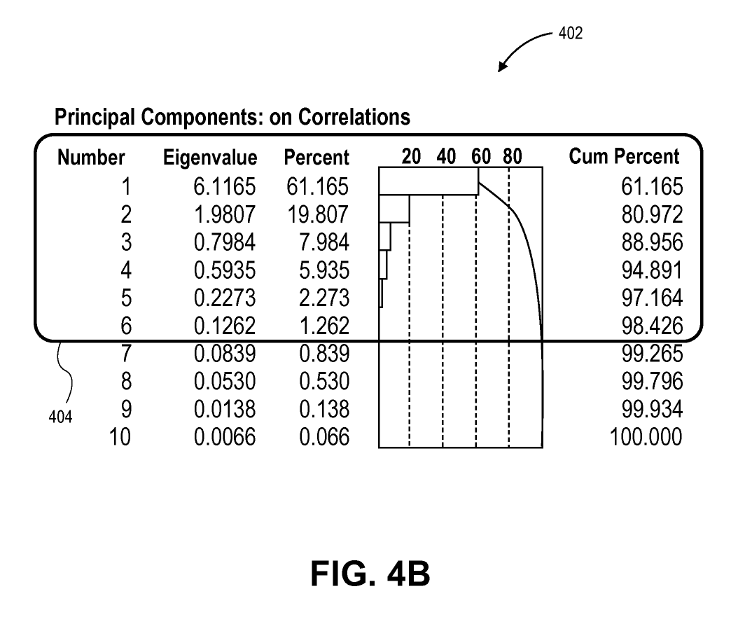

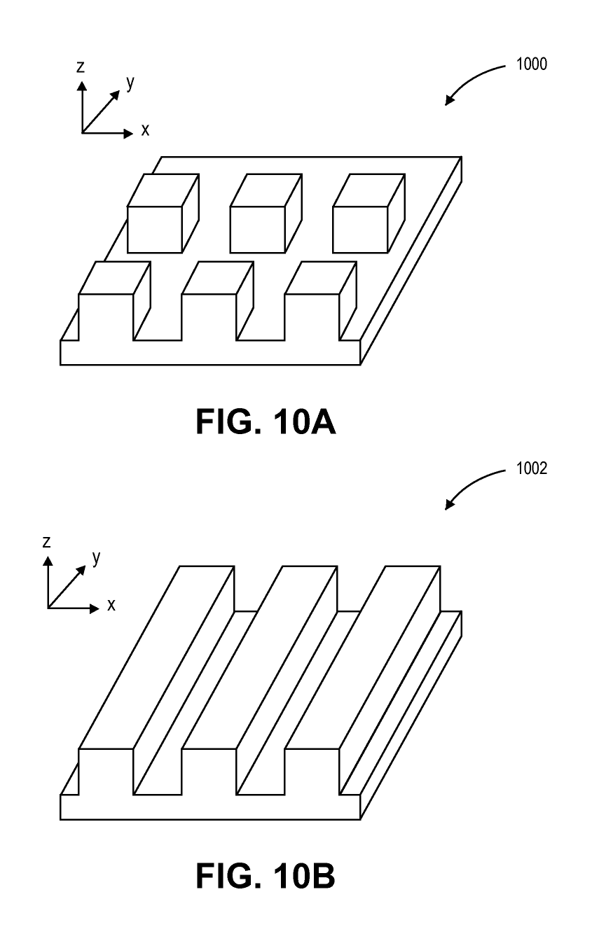

As an even more specific example, FIGS. 4A and 4B illustrate a plot 400 for 10 floated parameters, and a corresponding correlation outcome 402 for the 10 parameters, respectively, in accordance with an embodiment of the present invention. Referring to FIGS. 4A and 4B, 10 geometric parameters are floated to fit the data. However, only six degrees of freedom (DOF) are actually needed (e.g., correlation less than 99%), as indicated by box 404. In another specific example, multi-dimensional minima may be difficult to visualize, but drill thru plots suggest that multiple minima may exist in some correlations (this has also been confirmed by regression). DOF reduction may be introduced to address such circumstances as well.

In general, orders of a diffraction signal may be simulated as being derived from a periodic structure. The zeroth order represents a diffracted signal at an angle equal to the angle of incidence of a hypothetical incident beam, with respect to the normal N of the periodic structure. Higher diffraction orders are designated as +1, +2, +3, −1, −2, −3, etc. Other orders known as evanescent orders may also be considered. In accordance with an embodiment of the present invention, a simulated diffraction signal is generated for use in optical metrology. For example, profile parameters, such as structural shape and film thicknesses, may be modeled for use in optical metrology. Optical properties of materials, such as index of refraction and coefficient of extinction, (n & k), in structures may also be modeled for use in optical metrology.

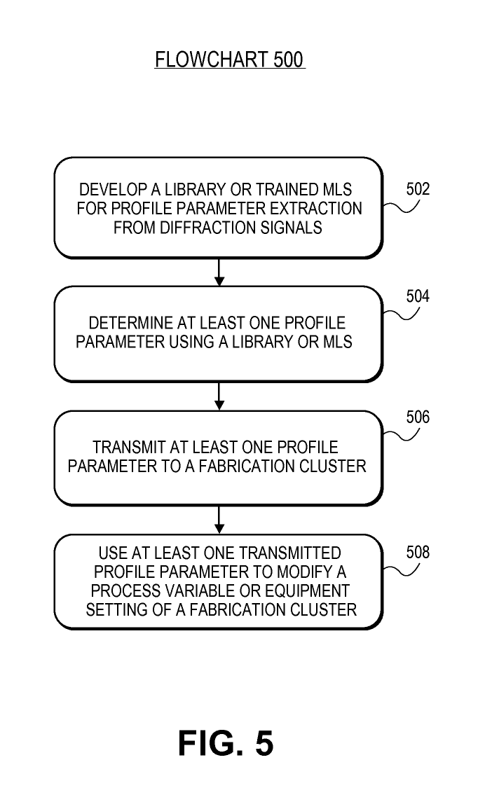

Calculations based simulated diffraction orders may be indicative of profile parameters for a patterned film, such as a patterned semiconductor film or structure based on a stack of films, and may be used for calibrating automated processes or equipment control. FIG. 5 depicts a flowchart 500 representing an exemplary series of operations for determining and utilizing structural parameters for automated process and equipment control, in accordance with an embodiment of the present invention.

Referring to operation 502 of flowchart 500, a library or trained machine learning systems (MLS) is developed to extract parameters from a set of measured diffraction signals. In operation 504, at least one parameter of a structure is determined using the library or the trained MLS. In operation 506, the at least one parameter is transmitted to a fabrication cluster configured to perform a processing operation, where the processing operation may be executed in the semiconductor manufacturing process flow either before or after measurement operation 504 is made. In operation 508, the at least one transmitted parameter is used to modify a process variable or equipment setting for the processing operation performed by the fabrication cluster.

For a more detailed description of machine learning systems and algorithms, see U.S. Pat. No. 7,831,528, entitled OPTICAL METROLOGY OF STRUCTURES FORMED ON SEMICONDUCTOR WAFERS USING MACHINE LEARNING SYSTEMS, filed on Jun. 27, 2003, which is incorporated herein by reference in its entirety. For a description of diffraction order optimization for two dimensional repeating structures, see U.S. Pat. No. 7,428,060, entitled OPTIMIZATION OF DIFFRACTION ORDER SELECTION FOR TWO-DIMENSIONAL STRUCTURES, filed on Mar. 24, 2006, which is incorporated herein by reference in its entirety.

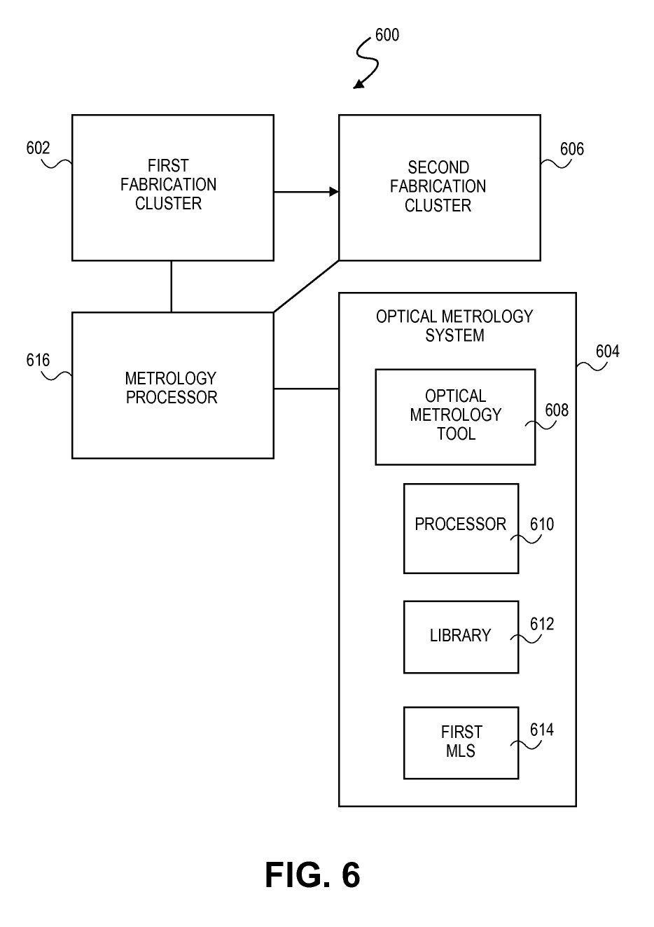

FIG. 6 is an exemplary block diagram of a system 600 for determining and utilizing structural parameters, such as profile or film thickness parameters, for automated process and equipment control, in accordance with an embodiment of the present invention. System 600 includes a first fabrication cluster 602 and optical metrology system 604. System 600 also includes a second fabrication cluster 606. Although the second fabrication cluster 606 is depicted in FIG. 6 as being subsequent to first fabrication cluster 602, it should be recognized that second fabrication cluster 606 can be located prior to first fabrication cluster 602 in system 600 (and, e.g., in the manufacturing process flow).

In one exemplary embodiment, optical metrology system 604 includes an optical metrology tool 608 and processor 610. Optical metrology tool 608 is configured to measure a diffraction signal obtained from the structure. If the measured diffraction signal and the simulated diffraction signal match, one or more values of the profile or film thickness parameters are determined to be the one or more values of the profile or film thickness parameters associated with the simulated diffraction signal.

In one exemplary embodiment, optical metrology system 604 can also include a library 612 with a plurality of simulated diffraction signals and a plurality of values of, e.g., one or more profile or film thickness parameters associated with the plurality of simulated diffraction signals. As described above, the library can be generated in advance. Metrology processor 210 can be used to compare a measured diffraction signal obtained from a structure to the plurality of simulated diffraction signals in the library. When a matching simulated diffraction signal is found, the one or more values of the profile or film thickness parameters associated with the matching simulated diffraction signal in the library is assumed to be the one or more values of the profile or film thickness parameters used in the wafer application to fabricate the structure.

System 600 also includes a metrology processor 616. In one exemplary embodiment, processor 610 can transmit the one or more values of the, e.g., one or more profile or film thickness parameters to metrology processor 616. Metrology processor 616 can then adjust one or more process parameters or equipment settings of first fabrication cluster 602 based on the one or more values of the one or more profile or film thickness parameters determined using optical metrology system 604. Metrology processor 616 can also adjust one or more process parameters or equipment settings of the second fabrication cluster 606 based on the one or more values of the one or more profile or film thickness parameters determined using optical metrology system 604. As noted above, fabrication cluster 606 can process the wafer before or after fabrication cluster 602. In another exemplary embodiment, processor 610 is configured to train machine learning system 614 using the set of measured diffraction signals as inputs to machine learning system 614 and profile or film thickness parameters as the expected outputs of machine learning system 614.

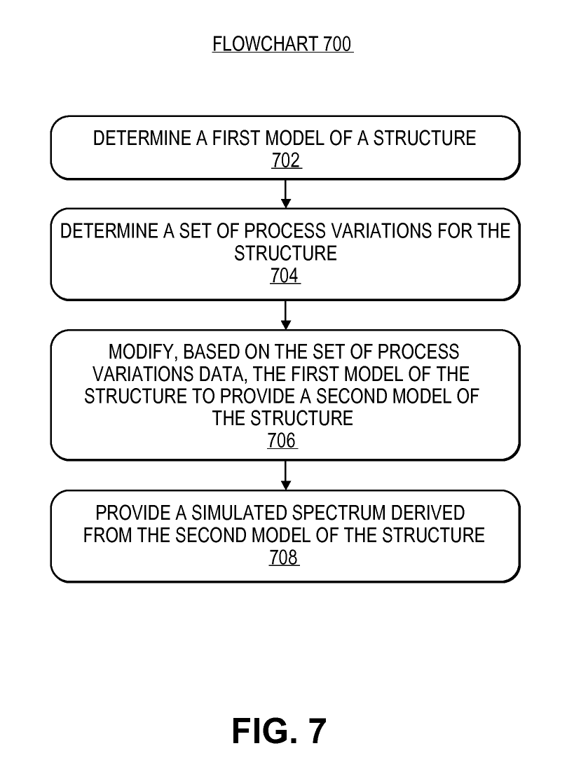

In an aspect of the present invention, a strategic approach to optimizing an optical model for two-dimensional or three-dimensional structures is provided. For example, FIG. 7 depicts a flowchart 700 representing operations in a method of process variation-based model optimization for metrology, in accordance with an embodiment of the present invention.

Referring to operation 702 of flowchart 700, a method of optimizing parametric models for structural analysis using metrology of repeating structures on a semiconductor substrate or wafer includes determining a first model of a structure. The first model is based on a first set of parameters. For example, the first model may have geometric parameters, material parameters, or other parameters that are not geometric or material.

Referring to operation 704 of flowchart 700, the method also includes determining a set of process variations data for the structure (e.g., variation ranges for bottom critical dimension (CD), top CD of the structure, middle CD or sidewall angle, or a combination thereof). In an embodiment, such determining includes obtaining actual process data, such as data physically measured from a tangible process flow of, e.g., wafers moving through a fabrication operation. In another embodiment, such determining includes obtaining synthetic process data (e.g., statistical-based or simulated model flow) based on a process analysis. In either case, the method includes defining the physical and realistic parameter spaces which may be based on customer data or require design of experiment (DOE) wafers, determining dependencies based on customer input and user intuition, or manually selecting profiles based on customer input and user intuition. Sampling of the parameter space may include a grid approach (e.g., as defined in equations in statistical software such as JMP), or a random approach (e.g., as may also be defined by equations in statistical software such as JMP).

Referring to operation 706 of flowchart 700, the method also includes modifying, based on the set of process variations data, the first model of the structure to provide a second model of the structure. The second model of the structure is based on a second set of parameters different from the first set of parameters. For example, in one such embodiment, the second model has parameters that are usually not directly associated with any geometry but may be based on process variations data.

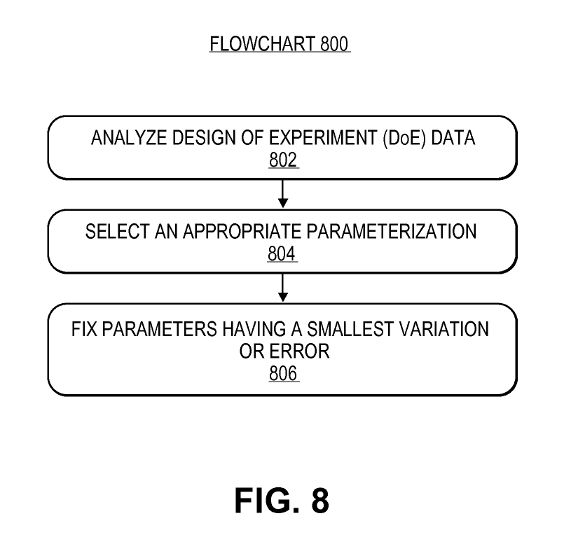

In an embodiment, the parameter space of the second model is reduced by reducing the DOF. Furthermore, only the subspace defined by the process variations may be used. Thus, in one embodiment, modifying the first model of the structure to provide the second model of the structure includes reducing the degrees of freedom (DoF) of the first set of parameters to provide the second set of parameters. It may be the case that the second model is the closest model to the original or first model. As an example, FIG. 8 depicts a flowchart 800 representing operations in a method of reducing the degrees of freedom (DoF) of a set of parameters, in accordance with an embodiment of the present invention. Referring to operation 802 of flowchart 800 reducing the DOF of the first set of parameters includes analyzing design of experiment (DOE) data, then selecting an appropriate parameterization (operation 804), and then fixing parameters having a smallest variation or error (operation 806).

In an embodiment, modifying the first model of the structure to provide the second model of the structure includes reparameterizing geometric parameters or material parameters, or both, to provide the second set of parameters. For example, feature selection may include selecting specific features or parameters by some criteria. In one specific such embodiment, reparameterizing geometric parameters includes using bottom critical dimension (CD) and top CD of the structure in the first set of parameters and using, in their place, middle CD and sidewall angle of the structure in the second set of parameters.

In another embodiment, modifying the first model of the structure to provide the second model of the structure includes reparameterizing non-geometric and non-material parameters to provide the second set of parameters. The non-geometric and non-material parameters are those such as, but not limited to, function+delta parameters, principal component analysis (PCA) parameters, or non-linear principal component analysis (NLPCA). For example, feature extraction may involve obtaining a reduced set of parameters by a transformation of original parameters. PCA parameterization may be performed with statistical software such as JMP. In a specific such example, the PCA is determined from the customer data or from a synthetic DOE, the PC equations are saved as PC equated to f(GP), a model GP is equated to the function f(PC), and constraint GP equated to f(PC) is used for modeling, such as in AcuShape™ (a product of TEL and KLA-Tencor), as described in greater detail below.

In an embodiment, the reparameterizing includes using function+delta parameters in linear or non-linear parameter correlations. This approach may also be based on process variation data. In one such embodiment, the reparameterizing includes reducing a library size of the second set of parameters relative to the first set of parameters. It is noted, however, that reducing a library size may be only one of several effects of applying the method.

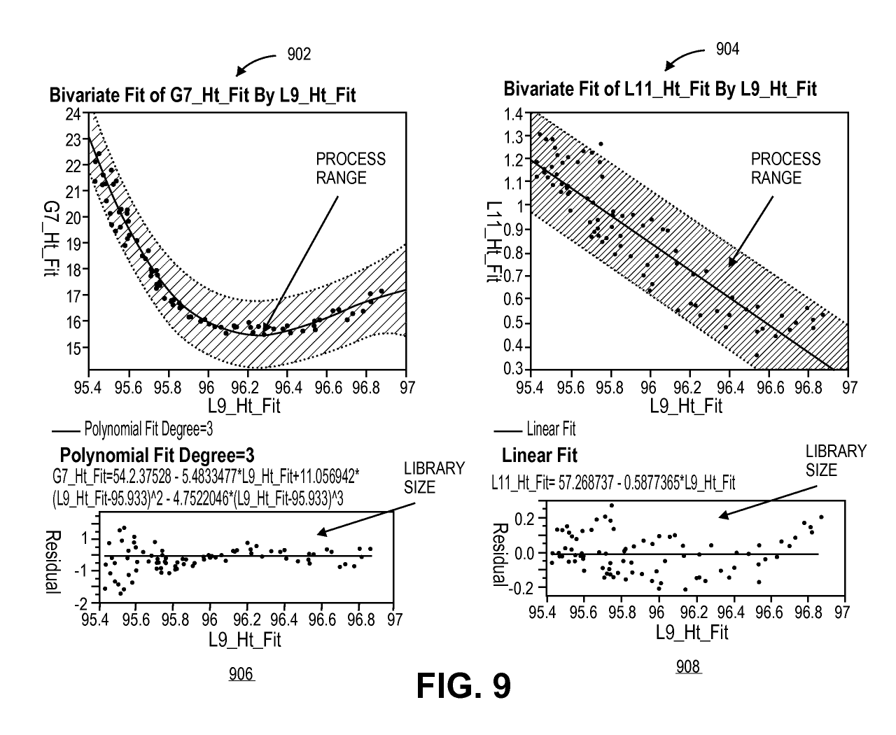

As an example, FIG. 9 includes plots 902 and 904 of possible process ranges which correspond to plots 906 and 908, respectively, of library size, in accordance with an embodiment of the present invention. Referring to plots 902 and 904, in an embodiment, for modeling there is no need to include samples outside of the range defined by the dashed lines. Referring to plots 906 and 908, in an embodiment, the library sizes include only the samples in the process range from plots 902 and 904, respectively. Extension and partitioning is performed in this space.

In an embodiment, modifying based on the set of process variations data includes sampling a space defined by set of process variations data. In one such embodiment, providing the second model of the structure includes performing a regression only in the space defined by set of process variations data. In another such embodiment, providing the second model of the structure includes performing analysis of one or more of auto wavelength selection, auto truncation order (TO), or auto truncation order pattern selection (TOPS) only in the space defined by set of process variations data, e.g., in a program such as Acushape. In another embodiment, modifying the first model of the structure based on the set of process variations data includes estimating a geometric parameter error of fixing a parameter in the second set of parameters. For example, parameters are fixed and/or DOF is reduced for the second model and the errors are measured in all the parameters of the first model (e.g., for geometric parameters, material parameters, or others).

Referring to operation 708 of flowchart 700, the method also includes providing a simulated spectrum derived from the second model of the structure. In an embodiment, further to that, the method further includes comparing the simulated spectrum to a sample spectrum derived from the structure. Embodiments describing approaches of performing such operations are described in greater detail below.

Thus, in one or more embodiments, a library quality is improved by reducing the library size (which may include reducing DOF) and/or reducing a process subspace. In an embodiment, a library generation speed is improved as a result. In an embodiment, the quality of the library model is improved, e.g., by improving process space or providing a higher density. In an embodiment, regression quality is improved by improving the speed (e.g., by DOF reduction) or regressing only in the subspace defined by the process variations. In an embodiment, precision correlation prediction (analysis) is improved as a result. Accuracy, based on the process subspace, also may be improved.

In an embodiment, reparameterization is used to modify only the parameter space to process based parameter subspace. Reparameterization and DOF reduction may define the best approximation of the process based parameter subspace. The second model then approximates the first model with smallest errors. Analysis sensitivity and correlation may be improved by using realistic ranges. Overall, time to results may be improved by providing such systematic approaches to model optimization.

A new feature may be added to modeling software to accommodate one or more of the approaches described herein. For example, in an embodiment, a new AcuShape feature includes the ability to perform PC parameterization from regression results, parameterization of two correlated parameters (e.g., fit function+delta parameter), defining the process range expectations, e.g., by synthetic DOE (such as profile grids where the user selects the regions of process variation), and defining the process variation region by parameter equations.

In an embodiment, optimizing a model of a structure includes using a three-dimensional grating structure. The term “three-dimensional grating structure” is used herein to refer to a structure having an x-y profile that varies in two horizontal dimensions in addition to a depth in the z-direction. For example, FIG. 10A depicts a periodic grating 1000 having a profile that varies in the x-y plane, in accordance with an embodiment of the present invention. The profile of the periodic grating varies in the z-direction as a function of the x-y profile.

In an embodiment, optimizing a model of a structure includes using a two-dimensional grating structure. The term “two-dimensional grating structure” is used herein to refer to a structure having an x-y profile that varies in only one horizontal dimension in addition to a depth in the z-direction. For example, FIG. 10B depicts a periodic grating 1002 having a profile that varies in the x-direction but not in the y-direction, in accordance with an embodiment of the present invention. The profile of the periodic grating varies in the z-direction as a function of the x profile. It is to be understood that the lack of variation in the y-direction for a two-dimensional structure need not be infinite, but any breaks in the pattern are considered long range, e.g., any breaks in the pattern in the y-direction are spaced substantially further apart than the breaks in the pattern in the x-direction.

Embodiments of the present invention may be suitable for a variety of film stacks. For example, in an embodiment, a method for optimizing a parameter of a critical dimension (CD) profile or structure is performed for a film stack including an insulating film, a semiconductor film and a metal film formed on a substrate. In an embodiment, the film stack includes a single layer or multiple layers. Also, in an embodiment invention, an analyzed or measured grating structure includes both a three-dimensional component and a two-dimensional component. For example, the efficiency of a computation based on simulated diffraction data may be optimized by taking advantage of the simpler contribution by the two-dimensional component to the overall structure and the diffraction data thereof.

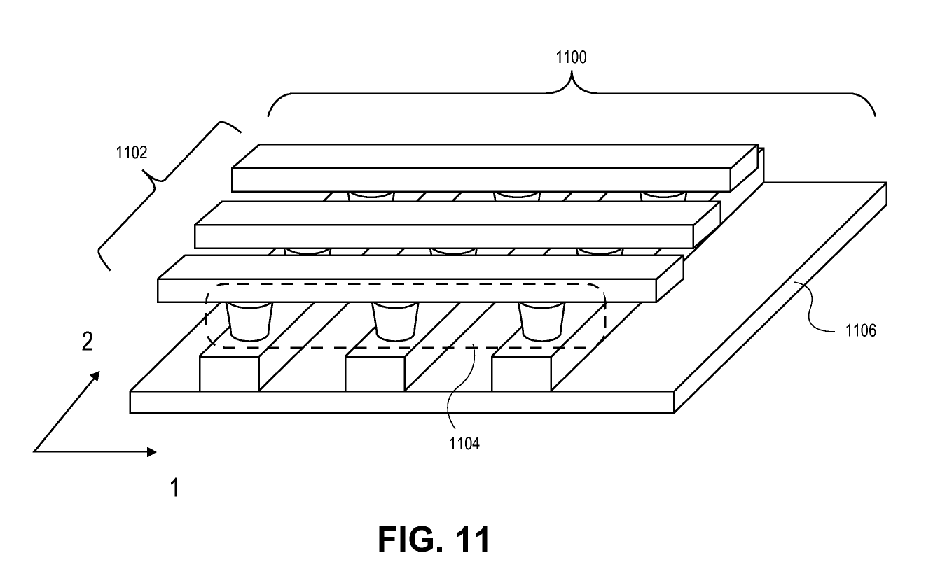

FIG. 11 represents a cross-sectional view of a structure having both a two-dimensional component and a three-dimensional component, in accordance with an embodiment of the present invention. Referring to FIG. 11, a structure 1100 has a two-dimensional component 1102 and a three-dimensional component 1104 above a substrate 1106. The grating of the two-dimensional component runs along direction 2, while the grating of the three-dimensional component runs along both directions 1 and 2. In one embodiment, direction 1 is orthogonal to direction 2, as depicted in FIG. 11. In another embodiment, direction 1 is non-orthogonal to direction 2.

The above methods may be implemented in an optical critical dimension (OCD) product such as “Acushape” as a utility for an applications engineer to use after initial or preliminary models have been tested. Also, commercially available software such as “COMSOL Multiphysics” may be used to identify regions of an OCD model for alteration. The simulation results from such a software application may be used to predict a region for successful model improvement.

In an embodiment, the method of optimizing a model of a structure further includes altering parameters of a process tool based on an optimized parameter. A concerted altering of the process tool may be performed by using a technique such as, but not limited to, a feedback technique, a feed-forward technique, and an in situ control technique.

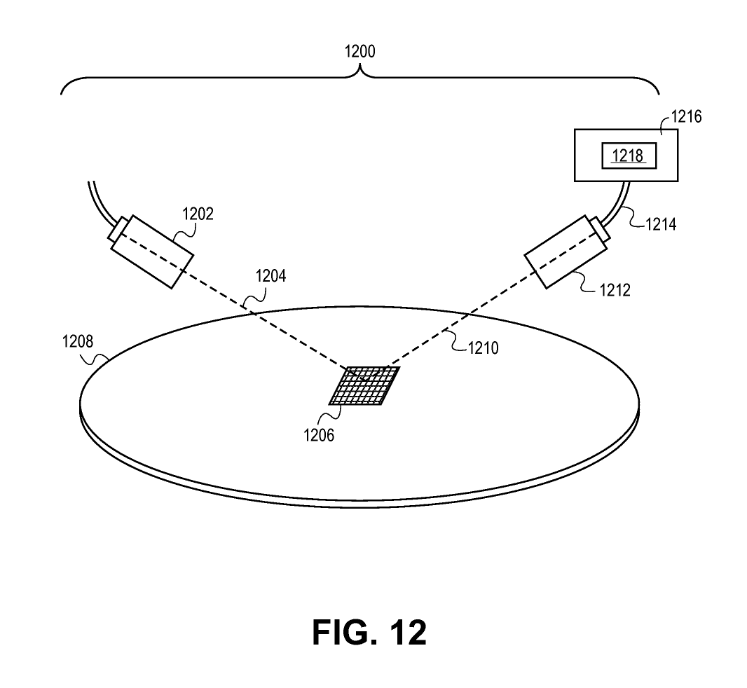

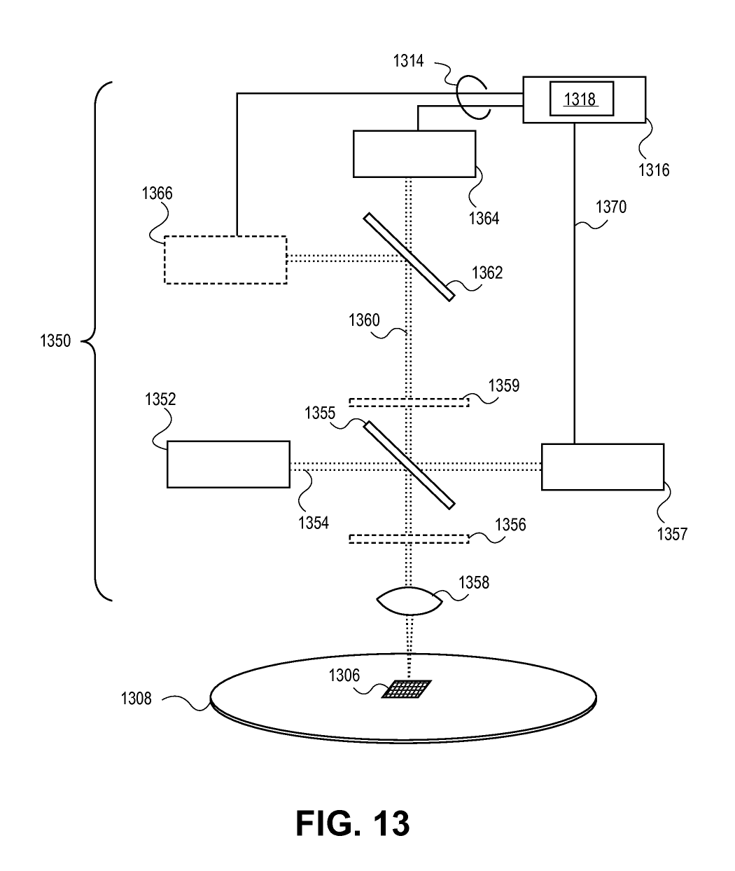

In accordance with an embodiment of the present invention, a method of optimizing a model of a structure further includes comparing a simulated spectrum to a sample spectrum. In one embodiment, a set of diffraction orders is simulated to represent diffraction signals from a two- or three-dimensional grating structure generated by an ellipsometric optical metrology system, such as the optical metrology systems 1200 or 1350 described below in association with FIGS. 12 and 13, respectively. However, it is to be understood that the same concepts and principles equally apply to the other optical metrology systems, such as reflectometric systems. The diffraction signals represented may account for features of the two- and three-dimensional grating structure such as, but not limited to, profile, dimension, material composition, or film thickness.

FIG. 12 is an architectural diagram illustrating the utilization of optical metrology to determine parameters of structures on a semiconductor wafer, in accordance with embodiments of the present invention. The optical metrology system 1200 includes a metrology beam source 1202 projecting a metrology beam 1204 at the target structure 1206 of a wafer 1208. The metrology beam 1204 is projected at an incidence angle θ towards the target structure 1206 (θ is the angle between the incident beam 1204 and a normal to the target structure 1206). The ellipsometer may, in one embodiment, use an incidence angle of approximately 60° to 70°, or may use a lower angle (possibly close to 0° or near-normal incidence) or an angle greater than 70° (grazing incidence). The diffraction beam 1210 is measured by a metrology beam receiver 1212. The diffraction beam data 1214 is transmitted to a profile application server 1216. The profile application server 1216 may compare the measured diffraction beam data 1214 against a library 1218 of simulated diffraction beam data representing varying combinations of critical dimensions of the target structure and resolution.

In one exemplary embodiment, the library 1218 instance best matching the measured diffraction beam data 1214 is selected. It is to be understood that although a library of diffraction spectra or signals and associated hypothetical profiles or other parameters is frequently used to illustrate concepts and principles, embodiments of the present invention may apply equally to a data space including simulated diffraction signals and associated sets of profile parameters, such as in regression, neural network, and similar methods used for profile extraction. The hypothetical profile and associated critical dimensions of the selected library 1216 instance is assumed to correspond to the actual cross-sectional profile and critical dimensions of the features of the target structure 1206. The optical metrology system 1200 may utilize a reflectometer, an ellipsometer, or other optical metrology device to measure the diffraction beam or signal.

In order to facilitate the description of embodiments of the present invention, an ellipsometric optical metrology system is used to illustrate the above concepts and principles. It is to be understood that the same concepts and principles apply equally to the other optical metrology systems, such as reflectometric systems. In an embodiment, the optical scatterometry is a technique such as, but not limited to, optical spectroscopic ellipsometry (SE), beam-profile reflectometry (BPR), beam-profile ellipsometry (BPE), and ultra-violet reflectometry (UVR). In a similar manner, a semiconductor wafer may be utilized to illustrate an application of the concept. Again, the methods and processes apply equally to other work pieces that have repeating structures.

FIG. 13 is an architectural diagram illustrating the utilization of beam-profile reflectometry and/or beam-profile ellipsometry to determine parameters of structures on a semiconductor wafer, in accordance with embodiments of the present invention. The optical metrology system 1350 includes a metrology beam source 1352 generating a polarized metrology beam 1354. Preferably this metrology beam has a narrow bandwidth of 10 nanometers or less. In some embodiments, the source 1352 is capable of outputting beams of different wavelengths by switching filters or by switching between different lasers or super-bright light emitting diodes. Part of this beam is reflected from the beam splitter 1355 and focused onto the target structure 1306 of a wafer 1308 by objective lens 1358, which has a high numerical aperture (NA), preferably an NA of approximately 0.9 or 0.95. The portion of the beam 1354 that is not reflected from the beam splitter is directed to beam intensity monitor 1357. The metrology beam may, optionally, pass through a quarter-wave plate 1356 before the objective lens 1358.

After reflection from the target the reflected beam 1360 passes back through the objective lens and is directed to one or more detectors. If optional quarter-wave plate 1356 is present, the beam will pass back through that quarter-wave plate before being transmitted through the beam splitter 1355. After the beam-splitter, the reflected beam 1360 may optionally pass through a quarter-wave plate at location 1359 as an alternative to location 1356. If the quarter-wave plate is present at location 1356, it will modify both the incident and reflected beams. If it is present at location 1359, it will modify only the reflected beam. In some embodiments, no wave plate may be present at either location, or the wave plate may be switched in and out depending on the measurement to be made. It is to be understood that in some embodiments it might be desirable that the wave plate have a retardance substantially different from a quarter wave, i.e. the retardance value might be substantially greater than, or substantially less than, 90°.

A polarizer or polarizing beam splitter 1362 directs one polarization state of the reflected beam 1360 to detector 1364, and, optionally, directs a different polarization state to an optional second detector 1366. The detectors 1364 and 1366 might be one-dimensional (line) or two-dimensional (array) detectors. Each element of a detector corresponds to a different combination of AOI and azimuthal angles for the corresponding ray reflected from the target. The diffraction beam data 1314 from the detector(s) is transmitted to the profile application server 1316 along with beam intensity data 1370. The profile application server 1316 may compare the measured diffraction beam data 1314 after normalization or correction by the beam intensity data 1370 against a library 1318 of simulated diffraction beam data representing varying combinations of critical dimensions of the target structure and resolution.

For more detailed descriptions of systems that could be used to measure the diffraction beam data or signals for use with the present invention, see U.S. Pat. No. 6,734,967, entitled FOCUSED BEAM SPECTROSCOPIC ELLIPSOMETRY METHOD AND SYSTEM, filed on Feb. 11, 1999, and U.S. Pat. No. 6,278,519 entitled APPARATUS FOR ANALYZING MULTI-LAYER THIN FILM STACKS ON SEMICONDUCTORS, filed Jan. 29, 1998, both of which are incorporated herein by reference in their entirety. These two patents describe metrology systems that may be configured with multiple measurement subsystems, including one or more of a spectroscopic ellipsometer, a single-wavelength ellipsometer, a broadband reflectometer, a DUV reflectometer, a beam-profile reflectometer, and a beam-profile ellipsometer. These measurement subsystems may be used individually, or in combination, to measure the reflected or diffracted beam from films and patterned structures. The signals collected in these measurements may be analyzed to determine parameters of structures on a semiconductor wafer in accordance with embodiments of the present invention.

Embodiments of the present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

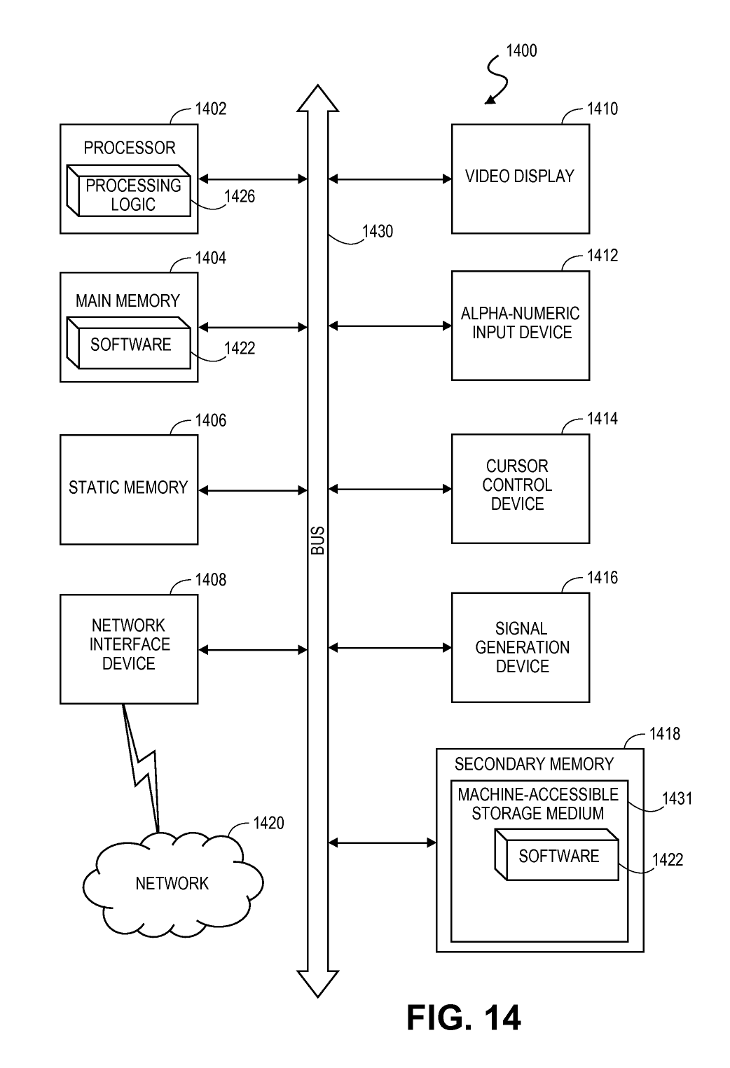

FIG. 14 illustrates a diagrammatic representation of a machine in the exemplary form of a computer system 1400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1400 includes a processor 1402, a main memory 1404 (e.g., read-only memory (ROM), flash memory, dynamic random access memory (DRAM) such as synchronous DRAM (SDRAM) or Rambus DRAM (RDRAM), etc.), a static memory 1406 (e.g., flash memory, static random access memory (SRAM), etc.), and a secondary memory 1418 (e.g., a data storage device), which communicate with each other via a bus 1430.

Processor 1402 represents one or more general-purpose processing devices such as a microprocessor, central processing unit, or the like. More particularly, the processor 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1402 may also be one or more special-purpose processing devices such as an application specific integrated circuit (ASIC), a field programmable gate array (FPGA), a digital signal processor (DSP), network processor, or the like. Processor 1402 is configured to execute the processing logic 1426 for performing the operations discussed herein.

The computer system 1400 may further include a network interface device 1408. The computer system 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), and a signal generation device 1416 (e.g., a speaker).

The secondary memory 1418 may include a machine-accessible storage medium (or more specifically a computer-readable storage medium) 1431 on which is stored one or more sets of instructions (e.g., software 1422) embodying any one or more of the methodologies or functions described herein. The software 1422 may also reside, completely or at least partially, within the main memory 1404 and/or within the processor 1402 during execution thereof by the computer system 1400, the main memory 1404 and the processor 1402 also constituting machine-readable storage media. The software 1422 may further be transmitted or received over a network 1420 via the network interface device 1408.

While the machine-accessible storage medium 1431 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

In accordance with an embodiment of the present invention, a machine-accessible storage medium has instructions stored thereon which cause a data processing system to perform a method of a method of optimizing parametric models for structural analysis using metrology of repeating structures on a semiconductor substrate or wafer. The method includes determining a first model of a structure. The first model is based on a first set of parameters. The method also includes determining a set of process variations data for the structure. The method also includes modifying the first model of the structure to provide a second model of the structure based on the set of process variations data. The second model of the structure is based on a second set of parameters different from the first set of parameters. The method also includes providing a simulated spectrum derived from the second model of the structure.

In an embodiment, the method further includes comparing the simulated spectrum to a sample spectrum derived from the structure.

In an embodiment, modifying the first model of the structure to provide the second model of the structure includes reducing the degrees of freedom (DoF) of the first set of parameters to provide the second set of parameters. In one such embodiment, reducing the DoF of the first set of parameters includes analyzing design of experiment (DoE) data, selecting an appropriate parameterization, and fixing parameters having a smallest variation or error.

In an embodiment, modifying the first model of the structure to provide the second model of the structure includes reparameterizing geometric parameters or material parameters, or both, to provide the second set of parameters. In one such embodiment, reparameterizing geometric parameters includes using bottom critical dimension (CD) and top CD of the structure in the first set of parameters and using, in their place, middle CD and sidewall angle of the structure in the second set of parameters.

In an embodiment, modifying the first model of the structure to provide the second model of the structure includes reparameterizing non-geometric and non-material parameters to provide the second set of parameters, the non-geometric and non-material parameters such as, but not limited to, function+delta parameters, principal component analysis (PCA) parameters, or non-linear principal component analysis (NLPCA). In one such embodiment, the reparameterizing includes using function+delta parameters in linear or non-linear parameter correlations. In a specific such embodiment, the reparameterizing includes reducing a library size of the second set of parameters relative to the first set of parameters.

In an embodiment, modifying based on the set of process variations data includes sampling a space defined by set of process variations data. In one such embodiment, providing the second model of the structure includes performing a regression only in the space defined by set of process variations data.

In an embodiment, determining the set of process variations data for the structure includes obtaining actual process data or synthetic process data based on a process analysis, or both.

In an embodiment, modifying the first model of the structure based on the set of process variations data includes estimating a geometric parameter error of fixing a parameter in the second set of parameters.

It is to be understood that the above methodologies may be applied under a variety of circumstances within the spirit and scope of embodiments of the present invention. For example, in an embodiment, measurements described above are performed with or without the presence of background light. In an embodiment, a method described above is performed in a semiconductor, solar, light-emitting diode (LED), or a related fabrication process. In an embodiment, a method described above is used in a stand-alone or an integrated metrology tool.

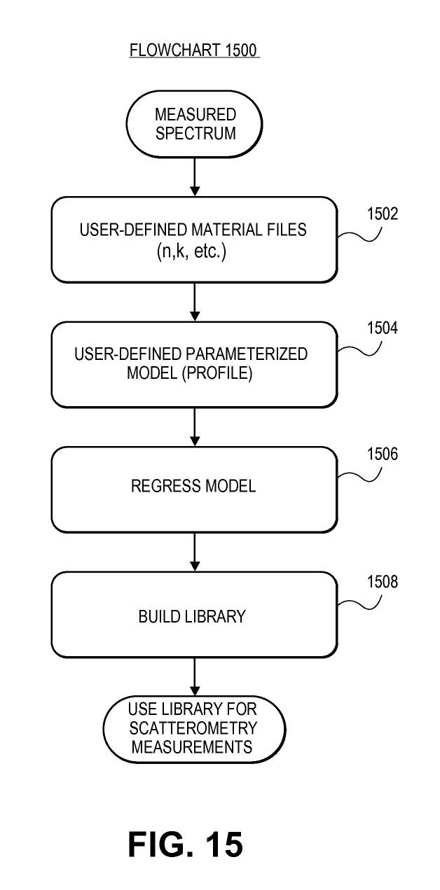

Analysis of measured spectra generally involves comparing the measured sample spectra to simulated spectra to deduce parameter values of a model that best describe the measured sample. FIG. 15 is a flowchart 1500 representing operations in a method for a building parameterized model and a spectral library beginning with sample spectra (e.g., originating from one or more workpieces), in accordance with an embodiment of the present invention.

At operation 1502, a set of material files are defined by a user to specify characteristics (e.g., refractive index or n, k values) of the material(s) from which the measured sample feature is formed.

At operation 1504, a scatterometry user defines a nominal model of the expected sample structure by selecting one or more of the material files to assemble a stack of materials corresponding to those present in the periodic grating features to be measured. Such a user-defined model may be further parameterized through definition of nominal values of model parameters, such as thicknesses, critical dimension (CD), sidewall angle (SWA), height (HT), edge roughness, corner rounding radius, etc. which characterize the shape of the feature being measured. Depending on whether a two-dimensional model (i.e., a profile) or three-dimensional model is defined, it is not uncommon to have 30-50, or more, such model parameters.

From a parameterized model, simulated spectra for a given set of grating parameter values may be computed using rigorous diffraction modeling algorithms, such as Rigorous Coupled Wave Analysis (RCWA). Regression analysis is then performed at operation 1506 until the parameterized model converges on a set of parameter values characterizing a final profile model (for two-dimensional) that corresponds to a simulated spectrum which matches the measured diffraction spectra to a predefined matching criterion. The final profile model associated with the matching simulated diffraction signal is presumed to represent the actual profile of the structure from which the model was generated.

The matching simulated spectra and/or associated optimized profile model can then be utilized at operation 1508 to build a library of simulated diffraction spectra by perturbing the values of the parameterized final profile model. The resulting library of simulated diffraction spectra may then be employed by a scatterometry measurement system operating in a production environment to determine whether subsequently measured grating structures have been fabricated according to specifications. Library generation 1508 may include a machine learning system, such as a neural network, generating simulated spectral information for each of a number of profiles, each profile including a set of one or more modeled profile parameters. In order to generate the library, the machine learning system itself may have to undergo some training based on a training data set of spectral information. Such training may be computationally intensive and/or may have to be repeated for different models and/or profile parameter domains. Considerable inefficiency in the computational load of generating a library may be introduced by a user's decisions regarding the size of a training data set. For example, selection of an overly large training data set may result in unnecessary computations for training while training with a training data set of insufficient size may necessitate a retraining to generate a library.

For some applications it may be unnecessary to build a library. After the parametric model of the structure has been created and optimized, a regression analysis similar to that described above may be used in real time to determine the best fitting parameter values for each target as the diffraction beam data are collected. If the structure is relatively simple (for example a 2D structure), or if only a small number of parameters need to be measured, regression may be fast enough even though it may be slower than using a library. In other cases, the extra flexibility of using regression may justify some increase in measurement time over using a library. For a more detailed description of methods and systems that are capable of real-time regression of OCD data for use with the present invention, see U.S. Pat. No. 7,031,848, entitled REAL TIME ANALYSIS OF PERIODIC STRUCTURES ON SEMICONDUCTORS, filed on Jul. 8, 2005, which is incorporated herein by reference in its entirety.

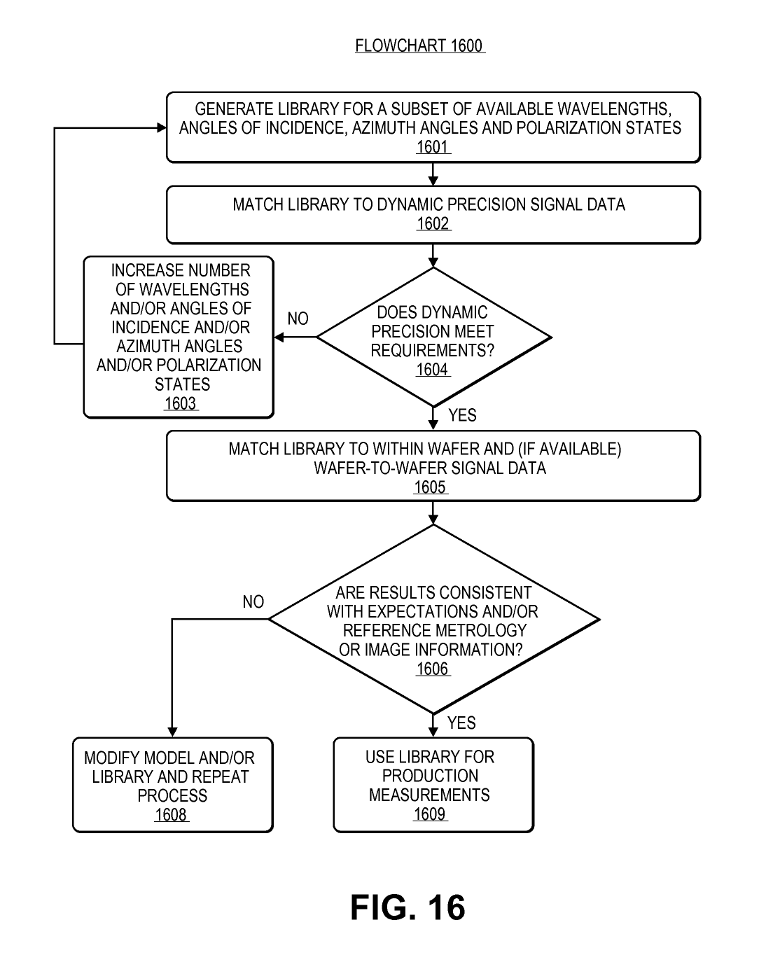

FIG. 16 depicts a flowchart 1600 representing operations in a method of constructing and optimizing a library using an optical parametric model, in accordance with an embodiment of the present invention. Not every operation shown is always required. Some libraries may be optimized using a subset of the operations shown. It should be understood that some of these operations may be performed in a different sequence or that additional operations may be inserted into the sequence without departing from the scope of the present invention.

Referring to operation 1601, a library is created using a parametric model. That parametric model may have been created and optimized using a process such as the process described in association with flowchart 700. The library is preferably created for a subset of the available wavelengths and angles in order to keep the library size small and to speed the library match or search. The library is then used to match dynamic precision signal data as shown at operation 1602 and hence determine the precision or repeatability of the measurement using that library. If the resulting precision does not meet requirements (operation 1604), then the number of wavelengths and/or angles and/or polarization states used needs to be increased as shown at operation 1603 and the process repeated. It is to be understood that if the dynamic precision is significantly better than required, it may be desirable to reduce the number of wavelengths and/or angles and/or polarization states in order to make a smaller, faster library. Embodiments of the present invention can be used to determine which additional wavelengths, angles or incidence, azimuth angles and/or polarizations states to include in the library.

When the library has been optimized for precision, any additional data that is available can be matched using that library as shown at operation 1605. The results from the larger set of data can be compared with reference data such as cross-section electron micrographs and also checked for consistency between wafers (for example, two wafers processed on the same equipment will usually show similar across-wafer variations) as shown at operation 1606. If the results meet expectations, then the library is ready for scatterometry measurements of production wafers (operation 1609). If the results do not meet expectations, then the library and/or parametric model need to be updated and the resulting new library retested (operation 1608). One or more embodiments of the present invention can used to determine what changes have to be made to the library or parametric model to improve the results.

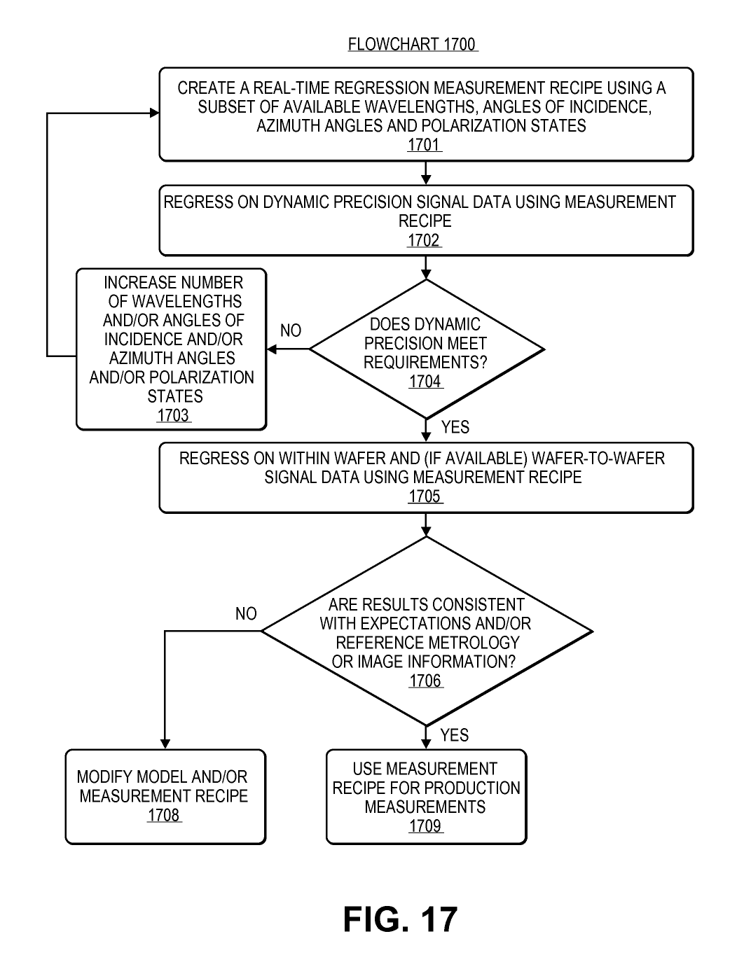

FIG. 17 depicts a flowchart 1700 representing operations in a method of constructing and optimizing a real-time regression measurement recipe using an optical parametric model, in accordance with an embodiment of the present invention. Not every operation shown is always required. Some real-time regression measurement recipes may be optimized using a subset of the operations shown. It should be understood that some of these operations may be performed in a different sequence or that additional operations may be inserted into the sequence without departing from the scope of the present invention.

Referring to operation 1701, a real-time regression measurement recipe is created using a parametric model. That parametric model may have been created and optimized using a process such as the method described in association with flowchart 700. The recipe is preferably created for a subset of the available wavelengths and angles in order to keep the computation time as short as possible. The recipe is then used to regress on the dynamic precision signal data as shown at operation 1702 and hence determine the precision or repeatability of the measurement using that library. If the resulting precision does not meet requirements (operation 1704), then the number of wavelengths and/or angles and/or polarization states used needs to be increased as shown at operation 1703 and the process repeated. It is to be understood that if the dynamic precision is significantly better than required, it may be desirable to reduce the number of wavelengths and/or angles and/or polarization states in order to make a faster recipe. Embodiments of the present invention can be used to determine which additional wavelengths, angles or incidence, azimuth angles and/or polarizations states to include in the recipe.

When the recipe has been optimized for precision, any additional data that is available can be regressed using that recipe as shown at operation 1705. The results from the larger set of data can be compared with reference data such as cross-section electron micrographs and also checked for consistency between wafers (for example, two wafers processed on the same equipment will usually show similar across-wafer variations) as shown at operation 1706. If the results meet expectations, then the recipe is ready for scatterometry measurements of production wafers (operation 1709). If the results do not meet expectations, then the recipe and/or parametric model need to be updated and the resulting new recipe retested (operation 1708). One or more embodiments of the present invention can used to determine what changes have to be made to the recipe or parametric model to improve the results.

As illustrated in the above examples, the process of developing parametric models and libraries and real-time regression recipes that use those parametric models is often an iterative process. The present invention can significantly reduce the number of iterations required to arrive at parametric model and the libraries or real-time regression recipe using that model as compare with a trial-end-error approach. The present invention also significantly improves the measurement performance of the resulting parametric models, libraries and real-time regression recipes since the model parameters, wavelengths, angles of incidence, azimuthal angles and polarization states can all be chosen based on optimizing sensitivity and reducing correlations.

It is also to be understood that embodiments of the present invention also include the use of the techniques related to machine learning systems such as neural networks and support vector machines to generate simulated diffraction signals.

Thus, methods of process variation-based model optimization for metrology have been disclosed. In accordance with an embodiment of the present invention, a method includes determining a first model of a structure. The first model is based on a first set of parameters. A set of process variations data is determined for the structure. The first model of the structure is modified to provide a second model of the structure based on the set of process variations data. The second model of the structure is based on a second set of parameters different from the first set of parameters. A simulated spectrum derived from the second model of the structure is then provided. In one embodiment, modifying the first model of the structure to provide the second model of the structure includes reducing the degrees of freedom (DoF) of the first set of parameters to provide the second set of parameters.

What is claimed is:

1. A method of optimizing parametric models for structural analysis using metrology of repeating structures on a semiconductor substrate or wafer, the method comprising:
determining a first model of a structure, the first model based on a first set of parameters;
determining a set of process variations data for the structure;
modifying, based on the set of process variations data, the first model of the structure to provide a second model of the structure, the second model of the structure based on a second set of parameters different from the first set of parameters; and
providing a simulated spectrum derived from the second model of the structure.

2. The method of claim 1, the method further comprising:
comparing the simulated spectrum to a sample spectrum derived from the structure.

3. The method of claim 1, wherein modifying the first model of the structure to provide the second model of the structure comprises reducing the degrees of freedom (DoF) of the first set of parameters to provide the second set of parameters.

4. The method of claim 3, wherein reducing the DoF of the first set of parameters comprises:
analyzing design of experiment (DoE) data;
selecting an appropriate parameterization; and
fixing parameters having a smallest variation or error.

5. The method of claim 1, wherein modifying the first model of the structure to provide the second model of the structure comprises reparameterizing geometric parameters or material parameters, or both, to provide the second set of parameters.

6. The method of claim 5, wherein reparameterizing geometric parameters comprises using bottom critical dimension (CD) and top CD of the structure in the first set of parameters and using, in their place, middle CD and sidewall angle of the structure in the second set of parameters.

7. The method of claim 1, wherein modifying the first model of the structure to provide the second model of the structure comprises reparameterizing non-geometric and non-material parameters to provide the second set of parameters, the non-geometric and non-material parameters selected from the group consisting of function+delta parameters, principal component analysis (PCA) parameters, and non-linear principal component analysis (NLPCA).

8. The method of claim 7, wherein the reparameterizing comprises using function+delta parameters in linear or non-linear parameter correlations.

9. The method of claim 8, wherein the reparameterizing comprises reducing a library size of the second set of parameters relative to the first set of parameters.

10. The method of claim 1, wherein modifying based on the set of process variations data comprises sampling a space defined by set of process variations data.

11. The method of claim 10, wherein providing the second model of the structure comprises performing a regression only in the space defined by set of process variations data.

12. The method of claim 10, wherein providing the second model of the structure comprises performing analysis of one or more of auto wavelength selection, auto truncation order (TO), or auto truncation order pattern selection (TOPS) only in the space defined by set of process variations data.

13. The method of claim 1, wherein determining the set of process variations data for the structure comprises obtaining actual process data or synthetic process data based on a process analysis, or both.

14. The method of claim 1, wherein modifying the first model of the structure based on the set of process variations data comprises estimating a geometric parameter error of fixing a parameter in the second set of parameters.

15. A machine-accessible storage medium having instructions stored thereon which cause a data processing system to perform a method of optimizing parametric models for structural analysis using metrology of repeating structures on a semiconductor substrate or wafer, the method comprising:
determining a first model of a structure, the first model based on a first set of parameters;
determining a set of process variations data for the structure;
modifying, based on the set of process variations data, the first model of the structure to provide a second model of the structure, the second model of the structure based on a second set of parameters different from the first set of parameters; and
providing a simulated spectrum derived from the second model of the structure.

16. The storage medium as in claim 15, the method further comprising:
comparing the simulated spectrum to a sample spectrum derived from the structure.

17. The storage medium as in claim 15, wherein modifying the first model of the structure to provide the second model of the structure comprises reducing the degrees of freedom (DoF) of the first set of parameters to provide the second set of parameters.

18. The storage medium as in claim 17, wherein reducing the DoF of the first set of parameters comprises:
analyzing design of experiment (DoE) data;
selecting an appropriate parameterization; and
fixing parameters having a smallest variation or error.

19. The storage medium as in claim 15, wherein modifying the first model of the structure to provide the second model of the structure comprises reparameterizing geometric parameters or material parameters, or both, to provide the second set of parameters.

20. The storage medium as in claim 19, wherein reparameterizing geometric parameters comprises using bottom critical dimension (CD) and top CD of the structure in the first set of parameters and using, in their place, middle CD and sidewall angle of the structure in the second set of parameters.

21. The storage medium as in claim 15, wherein modifying the first model of the structure to provide the second model of the structure comprises reparameterizing non-geometric and non-material parameters to provide the second set of parameters, the non-geometric and non-material parameters selected from the group consisting of function+delta parameters, principal component analysis (PCA) parameters, and non-linear principal component analysis (NLPCA).

22. The storage medium as in claim 21, wherein the reparameterizing comprises using function+delta parameters in linear or non-linear parameter correlations.

23. The storage medium as in claim 22, wherein the reparameterizing comprises reducing a library size of the second set of parameters relative to the first set of parameters.

24. The storage medium as in claim 15, wherein modifying based on the set of process variations data comprises sampling a space defined by set of process variations data.

25. The storage medium as in claim 24, wherein providing the second model of the structure comprises performing a regression only in the space defined by set of process variations data.

26. The storage medium as in claim 24, wherein providing the second model of the structure comprises performing analysis of one or more of auto wavelength selection, auto truncation order (TO), or auto truncation order pattern selection (TOPS) only in the space defined by set of process variations data.

27. The storage medium as in claim 15, wherein determining the set of process variations data for the structure comprises obtaining actual process data or synthetic process data based on a process analysis, or both.

28. The storage medium as in claim 15, wherein modifying the first model of the structure based on the set of process variations data comprises estimating a geometric parameter error of fixing a parameter in the second set of parameters.

29. A system to generate a simulated diffraction signal to determine process parameters of a wafer application to fabricate a structure on a wafer using optical metrology, the system comprising:
a fabrication cluster configured to perform a wafer application to fabricate a structure on a wafer, wherein one or more process parameters characterize behavior of structure shape or layer thickness when the structure undergoes processing operations in the wafer application performed using the fabrication cluster; and
an optical metrology system configured to determine the one or more process parameters of the wafer application, the optical metrology system comprising:
a beam source and detector configured to measure a diffraction signal of the structure; and
a processor configured to determine a first model of a structure, the first model based on a first set of parameters, configured to determine a set of process variations data for the structure, configured to modify the first model of the structure to provide a second model of the structure based on the set of process variations data, the second model of the structure based on a second set of parameters different from the first set of parameters, and configured to provide a simulated spectrum derived from the second model of the structure.

30. The system of claim 29, further comprising:
a library of simulated diffraction signals and values of one or more process parameters associated with the simulated diffraction signals, wherein the simulated diffraction signals were generated using values of one or more shape or film thickness parameters, and wherein the values of the one or more shape or film thickness parameters used to generate the simulated diffraction signals were derived from the values of the one or more process parameters associated with the simulated diffraction signals.
